(19) United States
(12) Patent Application Publication
(10) Pub. No.: US 2019/0322123 A1
(43) Pub. Date: Oct. 24, 2019

(54) METHODS FOR COATING COMPOSITE ARTICLES

(71) Applicant: ADVANCED ENVIRONMENTAL RECYCLING TECHNOLOGIES, INC., Springdale, AR (US)

(72) Inventors: Gary HOBBS, Springdale, AR (US); Timothy D. MORRISON, Springdale, AR (US); David Keith CANNON, Columbia, TN (US)

(21) Appl. No.: 16/474,731

(22) PCT Filed: Jan. 2, 2018
(86) PCT No.: PCT/US2018/012093

§ 371 Date: Jun. 28, 2019

Related U.S. Application Data
(60) Provisional application No. 62/441,420, filed on Jan. 1, 2017.

(51) Int. Cl. B44C 5/04; B05D 1/28; B05D 3/02; B05D 3/08

(52) U.S. Cl. CPC B44C 5/043; B05D 1/28; B44F 9/02; B05D 3/08; B05D 3/0254

(57) ABSTRACT

Methods and devices for coating a composite substrate. A desired design can be applied to at least a portion of a substrate's one or more surfaces by indexing the substrate, a coating apparatus, or a combination thereof, during or between application of one or more contrast coatings. The term indexing refers to changing the position (e.g. angle, tilt) of the substrate and/or the coating apparatus, the speed of such positioning, the rate at which the coating is applied, or some combination thereof. By such indexing, the pattern (4A-C) applied to the substrate (2A-C) can be varied.

### CROSS-REFERENCE TO RELATED APPLICATION

This application claims priority to U.S. Provisional Application No. 62/441,420, filed Jan. 1, 2017 and hereby incorporated by reference.

### TECHNICAL FIELD

This disclosure describes methods and devices for coating a substrate to provide desirable physical, thermal, and aesthetic characteristics.

### BACKGROUND

Many industries (e.g., construction and automotive) now employ wood plastic composites (WPCs) and other composite substrates in commercial products; some project a billion dollar market for WPCs in the next decade. Compared to mineral or glass filled composites, WPCs can have lower specific gravity and better strength/weight ratio, while often being cheaper to make. They can also look like natural wood and require less maintenance. Certain aesthetic attributes (e.g., repeating patterns) may, however, be undesirable to consumers looking to closely match natural wood.

Various mechanisms and processes can be used to color or pattern WPCs. For example, WPCs can be made using profile extrusion practices where ingredients are melt mixed and extruded through a profile die to create a board. In-process coloring techniques generally incorporate pigments or colorants into the melt mixtures. Alternatively, distinct colored particles can be introduced into the melt mixture to create streaks at or near the surface for a variegated appearance.

Another approach involves co-extruding a melt processable capstock layer over a substrate to provide a durable outer layer. The capstock layer can be applied to a substrate's top or side surface using conventional coating or laminating techniques and may be colored using pigments or dyes. A substrate, such as a WPC, can be coated as it passes under the coating station in a linear direction. For multicolored finishes with multiple passes under a coating station, coatings can develop repeating patterns (viz., redundancies) that diminish overall aesthetic qualities. Such redundancies can be particularly noticeable when substrates are paired, like, for example, when multiple boards are used in a deck or other structure.

### SUMMARY

There is a need to enhance physical, thermal, and aesthetic characteristics of substrates, particularly composite substrates. This disclosure describes methods and devices that can enhance these characteristics. A desired design can be applied to a substrate's surface through variable indexing of the substrate, a coating apparatus, or combination thereof during or between application of one or more patterned coatings, such as a patterned contrast coating. Coating aspects that can be varied include, but are not limited, to coating angles, apparatus positions, substrate indexing speed, coating apparatus indexing speed, etc. Such variations can provide distinct or otherwise desirable designs for one or more substrates, reducing or creating artifacts, redundancies, or other undesirable or desirable aesthetic features typical of conventional substrate patterning methods and devices.

In one embodiment, a method includes applying a contrast coating onto a substrate to create a desired design by indexing either the substrate or a coating apparatus. In some embodiments, two or more contrast coatings can be applied. In some embodiments, one or more contrast coatings can be applied to a substrate by selective deposition, spraying, contact coating, roll coating, brush coating, or combinations thereof. In certain embodiments, the two or more contrast coatings can include different amounts or kinds of pigments or colorants. In other embodiments, the contrast coating can be opaque or translucent depending on the desired appearance or effect. In some embodiments, the contrast coating's composition can be selected to provide a durable and weatherable coating for harsh environments. In certain embodiments, a contrast coating can include a crosslinkable polymer. In certain embodiments, various layers (e.g., a base coat, primer, topcoat, etc.) can be applied onto a substrate in addition to a contrast coating. In some embodiments, applying a contrast coating to a substrate can include, partial or complete, drying or curing of the contrast agent. In other embodiments, partial or complete curing or solidifying of the contrast agent can form a durable coating on the substrate. In some embodiments, curing can include thermal, UV, moisture, or actinic curing. In some embodiments, a contrast coating can be applied to one or more substrate surfaces. In certain embodiments, the substrate can be embossed. In some embodiments, a substrate can be pigmented or colored during melt processing, which can enhance the appearance of the contrast coating. In some embodiments, a substrate can include various polymers, fillers, additives, or combinations thereof.

In another embodiment, a device includes a coating apparatus for applying at least one contrast coating onto a substrate, in which the coating apparatus or the substrate can be indexed to create a design during or between application of the at least one contrast coating. In some embodiments, the substrate can be indexed laterally during coating. In some embodiments, indexing of one or more coating apparatuses may occur in either a lateral, upstream, or downstream manner, or in some combination of these manners, relative to the substrate. In some embodiments, a device can include multiple coating stations, at least one of which can be indexed to apply a contrast coating. In some embodiments, multiple coating stations can be used to apply multiple contrast coatings to create different colors, features, and appearances, including a variegated look of natural wood appearance. In other embodiments, an embossing apparatus can be employed to provide a textured appearance.

End use compositions and articles formed using the disclosed methods and devices can have desired physical (hardness, strength, durability, etc.), thermal (heat absorption, etc.), or aesthetic (e.g., a natural wood-like appearance, repeating or non-repeating patterns, a design spanning more than one substrate, etc.) attributes. Such compositions and articles can be well-suited for building and architectural applications, such as decking products, siding, railing, fencing, rooting, and trim, among others. Other applications include use in furniture or benches.

The above summary is not intended to describe each illustrated embodiment or every implementation of the subject matter hereof. The detailed description more particularly exemplifies various illustrative embodiments.

### BRIEF DESCRIPTION OF THE DRAWINGS

FIG. 1 is an image of WPCs with varied designs akin to natural wood, formed using the disclosed methods and devices.

FIG. 2A is a top, layered view of a decking board formed using disclosed methods and devices of this disclosure.

FIG. 2B is a top, layered view of two contrast coatings applied to the decking board of FIG. 2A.

FIG. 3 is a schematic view of one embodiment a disclosed coating apparatus.

FIG. 4A is a top view of one embodiment of multiple coating stations of this disclosure.

FIG. 4B is a side view of FIG. 4A's multiple coating stations.

FIG. 5A is a top view of one embodiment of a multistage coating operation.

FIG. 5B is a conveyor view of FIG. 5A's multistage coating operation.

### DETAILED DESCRIPTION

Unless the context indicates otherwise the following terms shall have the following meaning and shall be applicable to the singular and plural:

The terms “a,” “an,” “the,” “at least one,” and “one or more” are used interchangeably. For example, “a” contrast coating means “one or more” contrast coatings.

The term “component” refers to any substance that includes a particular feature or structure. Examples of components include compounds, monomers, oligomers, polymers, and organic groups contained therein.

The term “composite” means a material including two or more chemically and physically distinct phases separated by a distinct interface, e.g., a mixture of a polymeric material and an additive or filler.

The term “composite substrate” refers to a polymeric material and an additive or filler that is suitable for receiving the disclosed contrast coating.

The terms “contrast coat” or “contrast coating” refers to a polymeric layer that may include pigments, dyes, or colorants and is on (e.g., applied onto) a composite substrate.

The term “crosslinkable polymer” refers to a polymeric material or composite that can be crosslinked upon exposure to moisture, heat, or actinic radiation after processing.

The term “design” refers to an aesthetic or ornamental feature (e.g., a pattern or the appearance of natural wood), created or formed through selected or consequential application of coatings to desired areas of a substrate.

The terms “index,” “indexed,” or “indexing” refers to changing the position (e.g., relative angle, tilt, height, etc.) of an object (e.g., a substrate or a coating applicator), the speed at which such objects are positioned, the rate at which a coating is applied (e.g., the rotational speed of a coating applicator roll), or some combination thereof in a predetermined manner during or between application of one or more coatings. For example, in embodiments using a patterned gravure roll applicator, indexing can include coordinating the location of a portion of the patterned gravure roll with a target area on a moving substrate, changing the roll axis angle, or creating or changing a rotational speed differential between the roll and substrate.

The term “infrared reflective additive” means an additive composition that has the ability to reflect infrared radiation and beneficially improve the thermal characteristics of a polymeric composite.

The term “infrared reflective colorant” refers to a pigment, colorant, or dye that reflects infrared radiation, typically at greater than about 30% of the incident infrared intensity.

The term “melt processable composition” means a formulation that is melt processed, typically at elevated temperatures, by means of a conventional polymer processing technique.

The term “melt processing technique” refers to a technique for applying thermal and mechanical energy to a process or polymer. Non-limiting examples include extrusion, injection molding, blow molding, rotomolding, or batch mixing.

The term “pattern” refers to an aesthetic feature (e.g., repeating or irregular) visually perceptible to an average viewer from at least about 1 meter away or closer.

The terms “polymer” and “polymeric” mean a molecule of high relative molecular mass, the structure of which essentially contains multiple repetitions of units derived, actually or conceptually, from molecules of low relative molecular mass.

The terms “preferred” and “preferably” refer to embodiments that may afford certain benefits, under certain circumstances. Other embodiments, however, may also be preferred, under the same or other circumstances. Furthermore, the recitation of one or more preferred embodiments does not imply that other embodiments are not useful, and is not intended to exclude other embodiments from the claimed scope.

The term “substrate” refers to a solid medium to which another substance is applied and to which that second substance may be bonded.

The term “wood plastic composite” or “WPC” means a composite material that includes a cellulosic filler and a polymer.

The recitation of numerical ranges using endpoints includes all numbers (e.g. 1 to 5 includes 1, 1.5, 3, 3.95, 4.2, 5, etc.) and subranges (e.g., 1 to 5 includes 1 to 4, 1.5 to 4.5, 1 to 2 etc.) subsumed within that range.

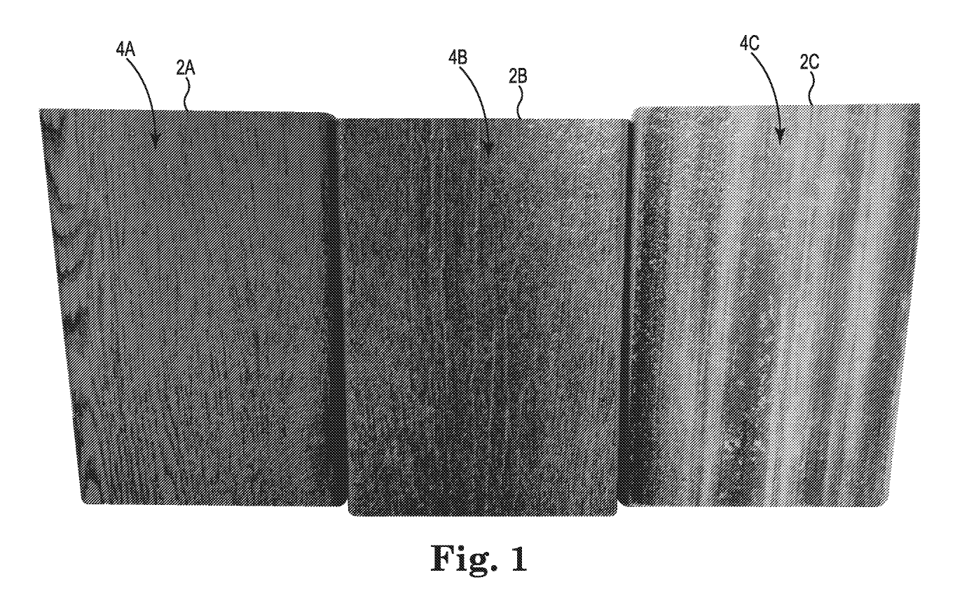

Desired designs (e.g., a wood-like appearance without repeating patterns or, in some cases, desired repeating patterns) can be imparted to at least a portion of one or more substrate surfaces by indexing either the substrate or a coating apparatus during or between application of one or more contrast coatings. Varying aspects of the coating process (e.g., coating angles, positions, or indexing speed) can reduce or create repeating patterns and otherwise provide a more desirable appearance. FIG. 1, for example, shows WPCs 2A, 2B, and 2C having designs 4A, 4B, and 4C, respectively. Designs 4A, 4B, and 4C exhibit distinct patterns, such that WPCs 2A, 2B, and 2C are distinguishable, as consumers might expect with natural wood. Reducing repeating patterns between substrates, as shown with WPCs 2A, 2B, and 2C and their respective designs, can mimic the variability of natural wood, which may be particularly noticeable when multiple substrates (e.g., decking boards) are used (e.g., placed or arranged) together in a structure (e.g., a deck).

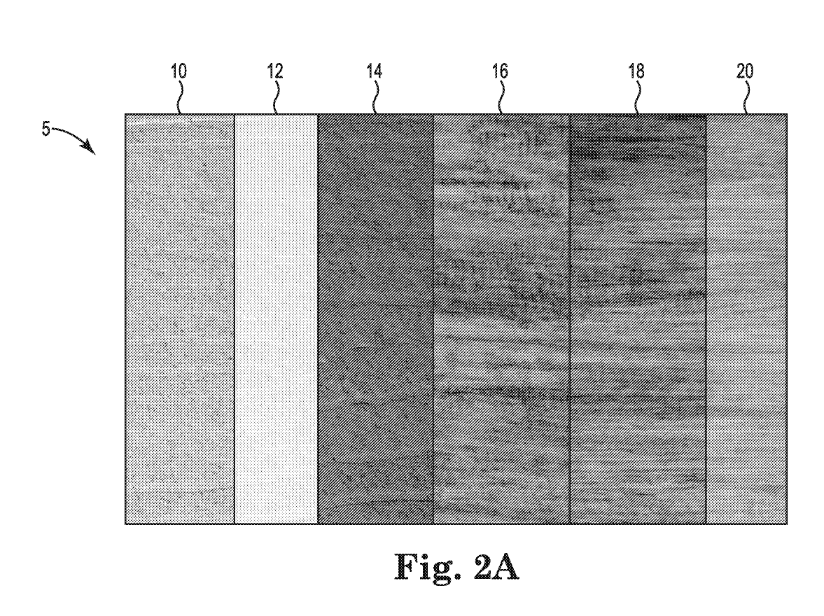

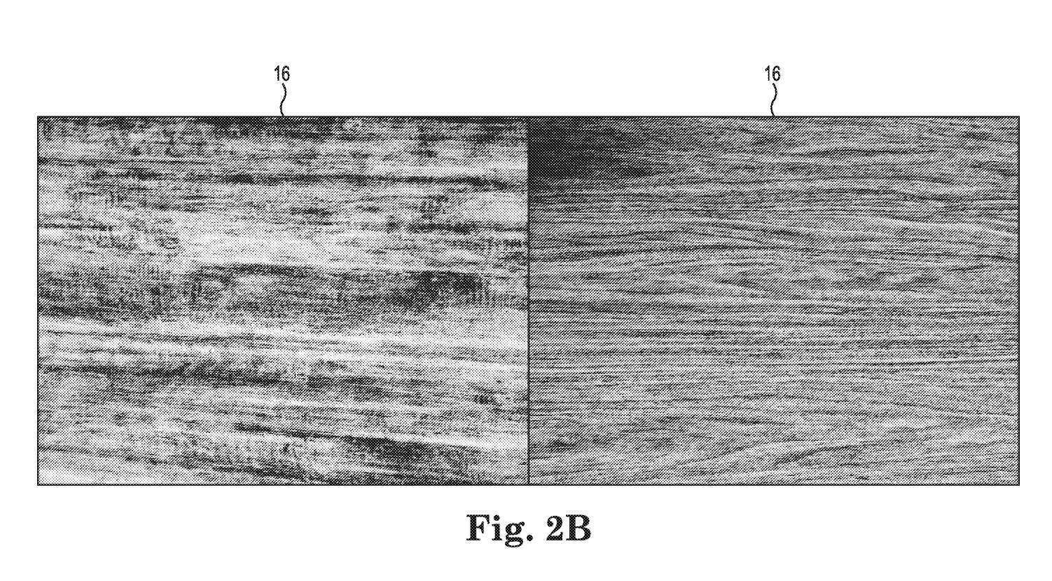

Depending on the application, a substrate can have other layers (e.g., a base coat, a primer, a top coat, a capstock layer, etc.) in addition to one or more contrast coatings. FIGS. 2A and 2B, for example, show top views of various potential layers of decking board 5, an article formed according to methods and devices disclosed herein. Decking board 5 includes WPC substrate 10, optional primer 12, optional base coat 14, contrast coating 16, contrast coating 18, and optional top coat 20. WPC 10 can be formed from a polymeric material and cellulosic filler using conventional melt processing techniques. Optional primer 12 and base coat 14 may be applied over a composite substrate, like WPC 10. In certain embodiments, base coat 14 may include infrared reflective compounds. One or more contrast coatings (e.g., contrast coatings 16 and 18) may be applied onto base coat 14 to create a design. Contrast coatings 16 and 18 can include a thermoplastic polymer, such as a polyolefin. Optional top coat 20 may then be applied over the at least one contrast coating as a protective, durable layer. In alternative embodiments, contrast coatings 16 and 18 and optional top coat 20 can include a crosslinkable polymer. An article formed according to this disclosure's methods and devices (e.g., decking board 5) can exhibit desirable physical, thermal, and aesthetic attributes imparted by the at least one contrast coating.

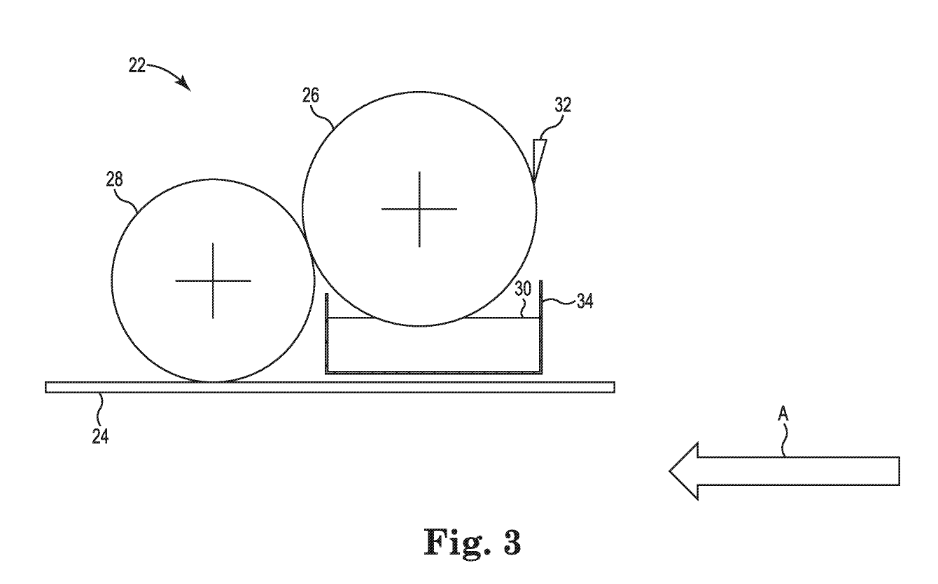

FIG. 3 depicts coating apparatus 22 suitable for applying at least one contrast coating to a substrate, here composite substrate 24. Coating apparatus 22 includes gravure roll 26, transfer roll 28, doctor blade 32, and open vessel 34, which contains contrast coating 30. Composite substrate 24 moves past coating apparatus 22 in the direction indicated by arrow A. Gravure roll 26 possesses a surface that can impart a particular design or pattern (not shown). Gravure roll 26 can be at least partially submerged in open vessel 34 holding contrast coating 30. Partially submerged gravure roll 26 picks off contrast coating 30 while passing over vessel 34. Excess contrast coating 30 can be removed from gravure roll 26 by doctor blade 32. The remaining contrast coating 30 with the selected design from gravure roll 26 is then transferred onto transfer roll 28 when rolls 26 and 28 contact each other. Transfer roll 28 comes in contact with composite substrate 24 as it passes by the gravure roll 26. In this manner, the original design on the patterned gravure roll passes onto the substrate. In accordance with this disclosure, coating apparatus 22 can be indexed laterally across substrate 24 upstream or downstream from the direction of movement of composite substrate 24. With the direct contact coating shown in FIG. 3, indexing of coating apparatus 22 can be moved before full contact is made or can be gradually moved while in contact with the composite substrate. Those of ordinary skill in the art familiar with coating processes will, in view of this disclosure, recognize that other non-contact coating methods may be employed and indexed during the coating process.

In some embodiments, a contrast coating can be pumped from a tank and metered to or on a transfer roll or gravure roll. In other embodiments, a contrast coating can be metered to a gravure roll and applied to a substrate.

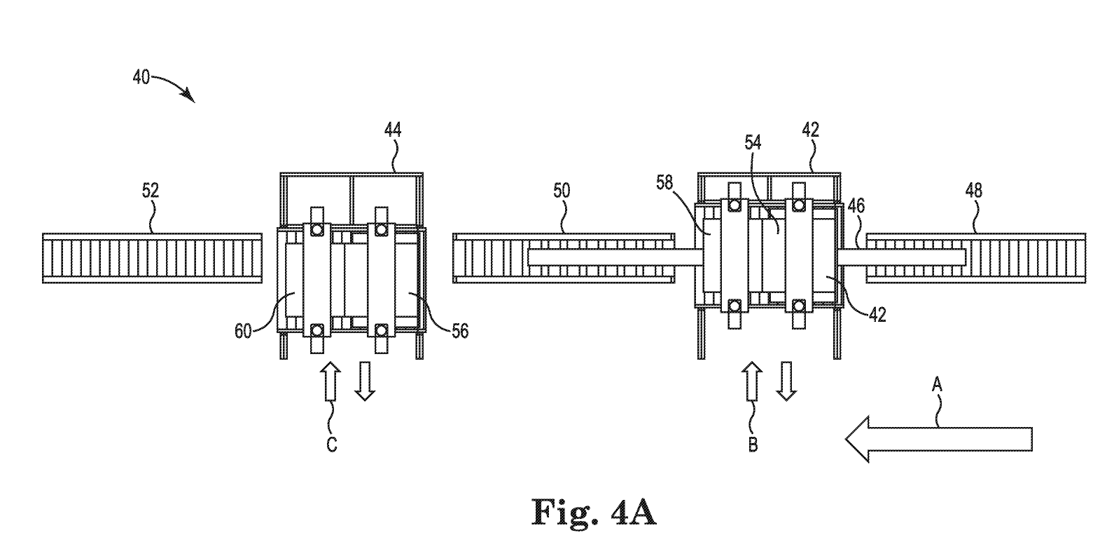

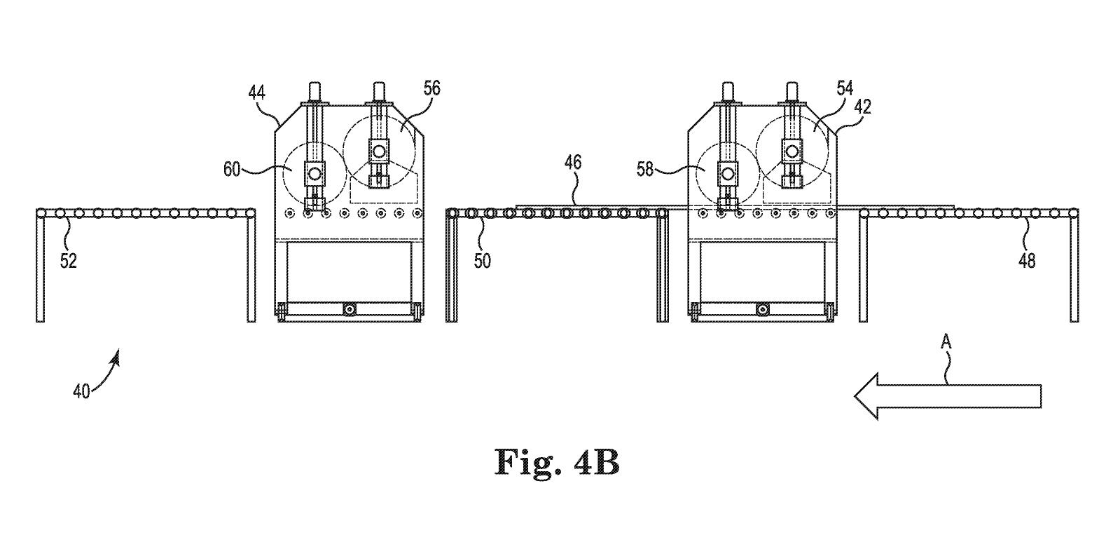

FIGS. 4A and 4B show top and side views, respectively, of multistage coating operation 40 using indexing coating stations 42 and 44 to coat composite substrate 46. Indexing coating station 42 includes gravure roll 54 and transfer roll 58; indexing coating station 44 includes gravure roll 56 and transfer roll 60. Composite substrate 46 is conveyed past indexing coating stations 42 and 44 by conveyors 48, 50, 52 in the direction of arrow A. Coating stations 42 and 44 apply a contrast coating (not shown) onto composite substrate 46. As depicted in FIG. 4A, the rolls in the coating stations 42, 44 can index in a direction lateral (indicated by arrows B and C) to the movement of composite substrate 46. The lateral movement at each coating station 42, 44 can provide a plurality of desired designs on the substrate.

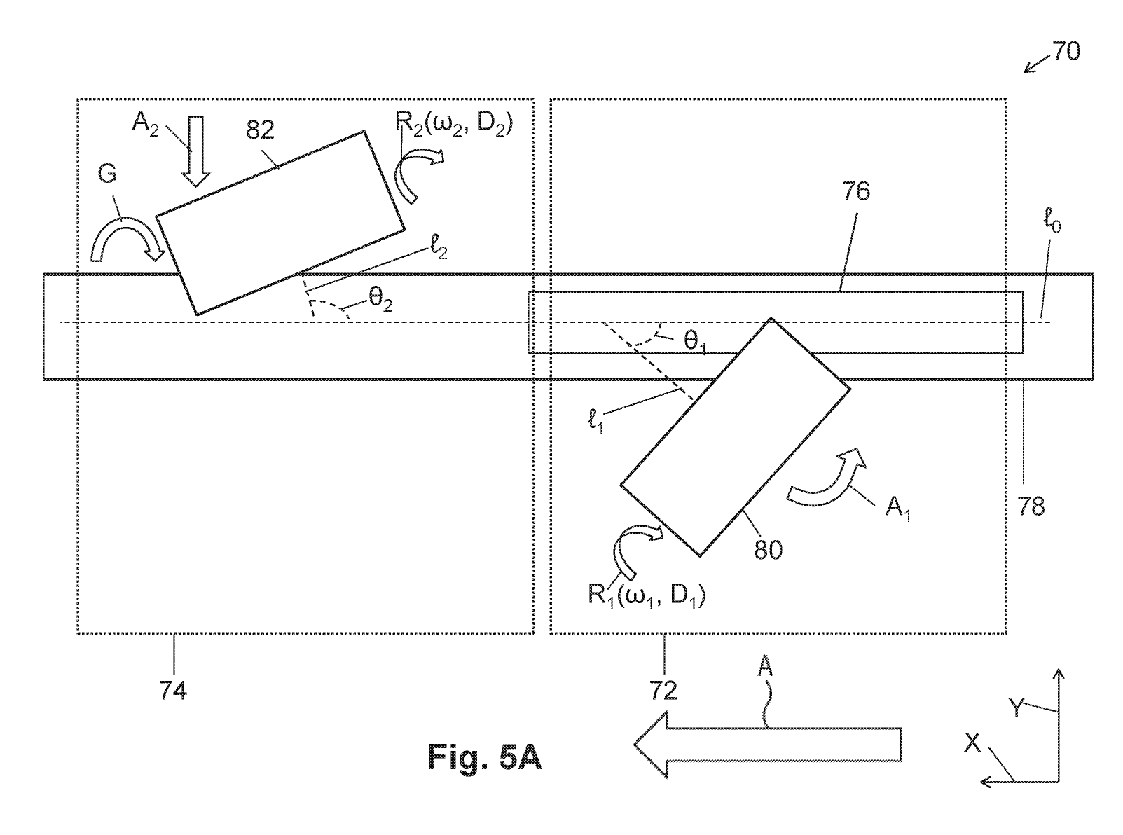

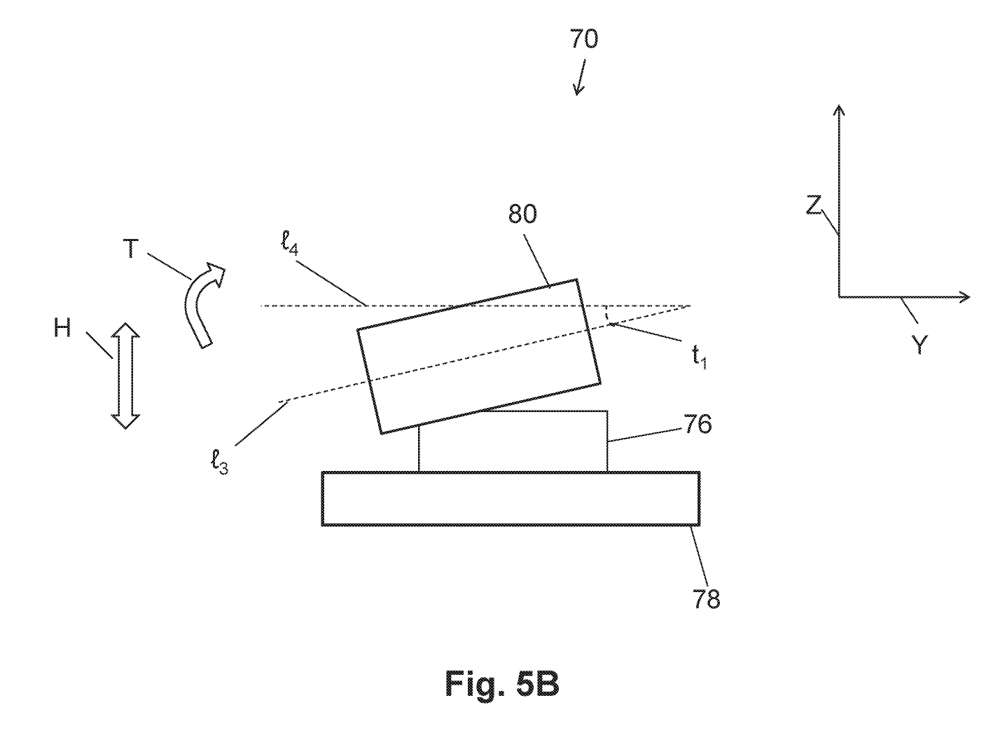

FIGS. 5A and 5B show a top and conveyor view of multistage coating operation 70 using coating stations 72 and 74 to coat substrate 76. FIGS. 5A and 5B include axes X, Y, and Z; lines l₀, l₂, l₂, l₃, and l₄; application angles θ₁ and θ₂; directional arrows A, A₁, and A₂; rotational arrows R₁ and R₂ illustrating rotational direction D₁ and D₂ and having rotational speeds ω₁ and ω₂, respectively; coating applicator roll height arrow H, coating applicator roll spin arrow G; tilt arrow T; and tilt angle t₁. Multistage coating operation 70 includes coatings stations 72 and 74. Coating station 72 includes coating applicator roll 80 (e.g., a gravure roll or a transfer roll); coating station 74 includes coating applicator roll 82. Coating applicator roll 80 is initially positioned at application angle θ₁ in a plane formed by axes X and Y, the angle defined by lines l₀, parallel to axis X, and l₁. Coating applicator roll 80 is positioned at tilt angle t₁ in a plane formed by axes Y and Z, the angle defined by lines l₃ and l₄, which is parallel to axis Y. Coating applicator roll 82 is initially positioned at angle θ₂ in a plane formed by axes X and Y, as defined by lines l₀ and l₂.

Conveying mechanism 78 conveys substrate 76 in coating station 72 in the direction of arrow A toward coating station 74. While coating (e.g., applying a contrast coating) or between coating applications, coating applicator roll 80 can be rotated to coat substrate 76 according to rotational arrow R₁, having rotational direction D₁ and ω₁, as it is moved in an arcuate manner shown by arrow A₁, such that θ₁ changes. The tilt of coating applicator roll 80 relative to substrate 76 can also be adjusted during or between coating applications. For example, as conveyor mechanism 78 indexes substrate A in the direction of arrow A, the position of coating applicator roll 80 can move in the direction of tilt arrow T in a plane formed by the Y and Z axes, such that tilt angle t₁ changes. The height of a coating applicator (e.g., coating applicator roll 80) can also be adjusted during or between coating applications. For example, the height of coating applicator roll 80 or composite substrate 76 can be indexed according to height arrow H to change the degree of contact or the contact pressure between the roll and the substrate. As substrate 76 enters coating station 74, coating applicator roll 82 can be rotated to coat substrate 76 according to rotational arrow R₂, having rotational direction D₂ and ω₂, as coating applicator roll 82 moves in the direction of arrow A₂, perpendicular to the movement of substrate 76 in the direction of arrow A. The tilt of coating applicator roll 82 can, for example, be held constant or adjusted. Coating applicator roll 82 can also be rotated in a plane defined by the X and Y axes, as shown by arrow G. Indexing sequences can be set to vary aspects of a coating operation (e.g., application angle θ₁, rotational speed ω₁, tilt angle t₁, contact pressure of coating applicator roll 80 on substrate 76, arcuate motion of coating applicator roll 80 in the direction of A₁, etc.) during or between coatings, which can provide distinct or predetermined patterns that reduce or create artifacts, redundancies, or otherwise provide a more desirable appearance.

In some embodiments, the indexing speed of a substrate (e.g., the rate at which substrate 76 is conveyed in the direction of arrow A) can be constant, variable, or some combination thereof. In some embodiments, the rate at which a coating is applied can be adjusted during or between applications of one or more coatings. For example, the rotational speed of a coating applicator roll (e.g., rotational speed ω₁) can be constant, variable, or some combination thereof. The direction of a coating applicator roll's rotation (e.g., rotational direction D₂), can also be controlled or adjusted, such that coating applicator roll can rotate in a clock-wise or counter-clockwise direction or not at all. In other embodiments, a coating applicator roll's rotation can be driven by the indexing speed of the substrate. In some embodiments, the tilt of the substrate or coating applicator can be adjusted with respect to the other (e.g., the tilt angle t₁ of coating applicator roll 80). In other embodiments, the contact pressure between a contact coating applicator and a substrate can be adjusted by setting the height (e.g., according to height arrow H) or tilt of the applicator, substrate, conveying mechanism, or some combination thereof. In other embodiments, coating angle, tilt, height, or some combination thereof can be adjusted during or between coating applications so that coating occurs on a desired portion of a substrate's surface. In some embodiments, a contact applicator (e.g., coating applicator roll 82) can be rotated in a plane formed by the X and Y axis, such that, for example, substrate 76 can be selectively exposed to varying widths of coating applicator roll 82 (e.g., as shown by arrow G). Such coating applicator roll rotational speeds can be held constant, varied, or some combination thereof.

In some embodiments, a coating operation (e.g., multi-stage coating operation 70) can include a conveying mechanism (e.g., conveying mechanism 78) having one or more conveyors. In some embodiments, a coating operation can have one or more types of coating applicators (e.g., a sprayer, a transfer roll, a gravure roll, etc.).

A variety of substrates may be suitable for use with the disclosed methods and devices. In some embodiments, a substrate can be a material that has a cross-sectional profile sufficient enough to form a rigid article. In some embodiments, a substrate's depth is substantially greater than the thickness of the contrast coating to be applied. In other embodiments, a substrate can be embossed. In a preferred embodiment, the substrate is a composite substrate. Non-limiting examples of commercially available composite substrates suitable for use with the disclosed methods and devices include Lumberock™ composite lumber, TimberTech™ deck boards, Trex™ composite decking, UltraDeck™ composite decking, and Veranda™ composite decking.

Various polymers can be used as a polymeric matrix in a substrate or capstock layer, including both hydrocarbon and non-hydrocarbon polymers. Non-limiting examples of useful polymeric matrices include polyamides, polyimides, polyurethanes, polyolefins, polystyrenes, polyesters, polycarbonates, polyketones, polyureas, polyvinyl resins, polyacrylates and polymethylacrylates.

In some embodiments, a substrate's polymeric matrix can include blended polymers. Non-limiting examples of polymers for blending include high density polyethylene (HDPE), low density polyethylene (LDPE), linear low density polyethylene (LLDPE), polypropylene (PP), polyolefin copolymers (e.g., ethylene-butene, ethylene-octene, ethylene vinyl alcohol), functionalized polyolefins (e.g. polyolefin based ionomers) polystyrene, polystyrene copolymers (e.g., high impact polystyrene, acrylonitrile butadiene styrene copolymer), polyacrylates, polymethacrylates, polyesters, polyvinylchloride (PVC), fluoropolymers, polyamides, polyether imides, polyphenylene sulfides, polysulfones, polyacetals, polycarbonates, polyphenylene oxides, polyurethanes, thermoplastic elastomers (e.g., SIS, SEBS, SBS), epoxies, alkyds, melamines, phenolics, ureas, vinyl esters or combinations thereof. Exemplary blends suitable for polymeric matrices can include polyolefins and thermoplastic elastomers.

A variety of fillers can be employed in a substrate. Non-limiting examples of fillers for the composite substrate include inorganic and organic fillers (e.g., talc, mica, clay, silica, alumina, carbon fiber, carbon black glass fiber) and conventional cellulosic materials (e.g., wood flour, wood fibers, sawdust, wood shavings, newsprint, paper, flax, hemp, wheat straw, rice hulls, kenaf, jute, sisal, peanut shells, soy hulls, or any cellulose containing material). In another aspect, polymeric fibers may also be incorporated in a composite substrate. Fillers may be provided in various forms depending on the polymeric matrix and end use application. Non-limiting examples of filler forms include powder and pellets.

Filler amounts may vary depending upon the polymeric matrix and the desired properties of the end use article. In view of this disclosure, the appropriate amount and type of filler(s) can be selected to match with a specific polymeric matrix in order to achieve desired properties of the finished material. Typically, the filler may be incorporated into the melt processable composition in amounts up to about 90% by weight. A melt processable composite composition can include a filler in an amount of at least about 5 wt %, or at least about 15 wt %, or at least about 25 wt %, and up to about 90 wt %, or up to about 80 wt %, or up to about 70% of the composition.

Various additives can be employed in a substrate. Non-limiting examples of additives include antioxidants, light stabilizers, fibers, blowing agents, foaming additives, antiblocking agents, heat stabilizers, impact modifiers, biocides, compatibilizers, flame retardants, plasticizers, tackifiers, colorants, processing aids, lubricants, coupling agents, pigments, and colorants and dyes.

Additives can be incorporated into the melt processable composition in the form of powders, pellets, granules, or in any other extrudable form. The amount and type of conventional additives in the melt processable composition can vary depending upon the polymeric matrix and the desired physical properties of the finished composition. In view of this disclosure, those skilled in the art of melt processing are capable of selecting appropriate amounts and types of additives to match with a specific polymeric matrix in order to achieve desired physical properties of the finished material.

Melt processing of the polymeric matrix can be performed at a temperature from 80° to 300° C., although optimum operating temperatures are selected depending upon the melting point, melt viscosity, and thermal stability of the overall composition. Different types of melt processing equipment, such as extruders, may be used to process the disclosed melt processable compositions used to form a substrate. A substrate's surface can be embossed to provide a structured surface appearance.

A substrate of a desired length, width, and cross sectional area can be coated with the at least one contrast coating of this disclosure. Coatings may be applied during or after the substrate's production. In some embodiments, discrete sections of substrates are coated with the at least one contrast coating. Examples of coatings include, but are not limited to, one or more of a pre-coat, primer, base coat, at least one contrast coat, and top coat.

A contrast or other coating can be applied to a substrate in a variety of ways. Non-limiting examples of coating processes include selective deposition, printing, spraying, contact coating, roll coating, brush coating, or combinations thereof. With each of these methods the application device or apparatus may be indexed to offer design variables for the one or more contrast coatings on a substrate.

Indexing can include various systems and processes that enable movement of a substrate or a coating apparatus during or between application of one or more contrast coatings. In view of this disclosure, those of ordinary skill in the art will recognize that electrical or mechanical controls, or a combination thereof, may be employed to vary the coating process to enhance the coating's features. In one embodiment, the coating apparatus can be designed to be supported by a device that allows for at least one degree of freedom. In another embodiment with roll coating devices, a screw-driven device, a programmable controller, and photoelectric sensors can detect when a substrate enters a coating apparatus to initiate a sequence that turns the screw for a set time period. As a result, different areas of a transfer roll contact the substrate as the substrate passes through the coating station. The sequence can be revised when the transfer roll is moved to one side of the coating apparatus. For a printing apparatus, programmable logic controllers can be used to generate variable index times and directions.

In another embodiment, a system of actuation devices with encoders can be used to provide positional feedback to a programmable logic controller to allow for specific positional control of the apparatus. This approach can be advantageous for providing a specific indexing sequences as well as for providing a random indexing sequences (e.g., by using a random number generator function of a programmable logic controller). In view of this disclosure, those of ordinary skill in the art can select an appropriate control system to meet the specific form or type of coating apparatus being used.

During or between one or more indexing sequences, various coating application angles (e.g., application angles θ₁ and θ₂) for a coating applicator (e.g., a sprayer or coating applicator roll) can be employed before, during, or after applications of one or more coatings to a substrate. Coating application angles can range, for example, from at least about 0°, at least about 5°, at least about 15°, at least about 25°, at least about 45°, at least about 60°, at least about 90°, and up to about 360°, up to about 350°, up to about 330°, up to about 315°, up to about 270°, up to about 225°, and up to about 180°. In preferred embodiments, coating application angles can range from at least about 0°, or at least about 1°, or at least about 2°, or at least about 5°, or at least about 10°, or at least about 15°, or at least about 30°, or at least about 45°, or at least about 60°, or at least about 90° (at which angle a coating applicator would apply a stripe), and up to about 180°, or up to about 179°, or up to about 178°, or up to about 175°, or up to about 170°, about or up to about 165°, or up to about 150°, or up to about 135°, or up to about 120°, or up to about 95°.

During or between one or more indexing sequences, various coating applicator rotation angles (e.g., rotation of coating applicator roll 82 indicated by arrow G in a plane defined by axes X and Y) can be employed before, during, or after application of one or more a coatings to a substrate. Coating applicator rotation angles can range, for example, can range from at least about 0°, at least about 5°, at least about 15°, at least about 25°, at least about 45°, at least about 60°, at least about 90°, and up to about 360°, up to about 350°, up to about 330°, up to about 315°, up to about 270°, up to about 225°, and up to about 180°. In preferred embodiments, coating applicator rotation angles can range from at least about 0°, or at least about 1°, or at least about 2°, or at least about 5°, or at least about 10°, or at least about 15°, or at least about 30°, or at least about 45°, or at least about 60°, or at least about 90° (at which angle a coating applicator would apply a stripe), and up to about 360°, or up to about 179°, or up to about 178°, or up to about 175°, or up to about 170°, about or up to about 165°, or up to about 150°, or up to about 135°, or up to about 120°, or up to about 95°.

During or between one or more indexing sequences, various coating applicator tilt angles (e.g., tilt angle t₁ of coating applicator roll 80) can be employed before, during, or after application of one or more a coatings to a substrate. Coating applicator tilt angles can range, for example, from at least about 0°, or at least about 15°, or at least about 30°, or at least about 45°, or at least about 60°, or at least about 90°, or at least about 135°, and up to about 360°, or up to about 350°, or up to about 330°, or up to about 315°, or up to about 270°, or up to about 225°, or up to about 180°. In preferred embodiments, coating applicator tilt angles can range from at least about 0°, or at least about 1°, or at least about 2°, or at least about 5°, or at least about 15°, or at least about 30°, and up to about 90°, or up to about 80°, or up to about 75°, or up to about 65°, or up to about 60°, or up to about 45°.

During or between one or more indexing sequences for a multi-roller coating operation, various roll rotation speeds (e.g., rotational speed ω₁) can be employed before, during, or after application of one or more to a substrate. In some embodiments, such an operation may employ one or more coating applicator rolls having no rotational speed, such that the roll drags along or across a substrate. In embodiments where one or more coating applicator rolls rotate, rotational speed differentials can be modeled as a percentage value (e.g., for rotational speed ω₁≥rotational speed ω₂, the rotational speed differential can be modeled as 100·(ω₁−ω₂)/ω₁). Operations with more than two coating applicator rolls can be modeled in similar fashion (e.g., for rotational speed ω₁≥rotational speed ω₂ and rotational speed ω₁≥rotational speed ω₃, the rotational speed differentials can be modeled as 100·(ω₁−ω₂)/ω₁ and 100·(ω₁−ω₃)/ω₁, respectively). Rotational speed differentials between one or more coating applicator rolls can range from at least about 0%, or at least about 5%, or at least about 20%, or at least about 45%, and up to about 100%, or up to about 95%, or up to about 80%, or up to about 60%.

Embodiments with multiple coatings, including two or more contrast coatings, may utilize a drying or curing step in order to apply an additional layer onto the composite substrate. Various conventional drying and curing practices may be used. For example, infrared heat, flash drying, gap drying or other conventional drying practices may be used between coating applications. Non-limiting examples of curing include thermal curing, UV curing, moisture curing or actinic energy curing.

A contrast coating's composition can vary depending on a particular application's demands. Some applications may, for example, require crosslinked compositions to meet certain durability requirements. Certain polymers can be well suited for particular applications. In some embodiments, thermoplastic polymers, like those listed above, can be used. Other non-limiting examples of polymers suitable for the at least one contrast coating include epoxies, polyurethanes, acrylics, and polyolefins. The polymers may be coated as a solid material or may be applied as solvent-borne or water-borne coatings. Non-limiting examples of solvents include alcohol solvents, ester solvents, ketone solvents, or combinations thereof. In some embodiments, a contrast coating can include one or more catalysts. A contrast coating's composition, including any catalysts, can be matched with other optional base coats and top coats to ensure sufficient interfacial bonding between coats.

In one embodiment, a contrast coating can include a crosslinkable polymer. Epoxy, polyurethane, acrylic, and polyolefins polymers are just one example of crosslinkable polymers suitable for use with the disclosed method and article. Non-limiting examples of crosslinkable polyolefins include silane grafted polyethylene, silane grafted polyethylene copolymers (e.g., ethylene/hexane, ethylene/octane, ethylene/vinyl acetate, ethylene/acrylate, ethylene/propylene) and silane grafted polypropylene. Silanes moieties grafted to the polymer backbone may include, for example, trimethoxy and triethoxy silane.

Crosslinking reactions can be activated using crosslinkable polymers or monomers and free radical initiators. Non-limiting free radical initiators are any of those known in the art including diazo compounds and peroxy compounds. In view of this disclosure, those skilled in the art will recognize that the appropriate selection of a free radical initiator may in some embodiments be determined by the melt processing conditions (e.g., temperature and residence time) required to facilitate effective grafting of the crosslinkable monomer to the polymer backbone. The crosslinking reaction can be optionally accelerated by including a catalyst in the formulation (e.g., in a capstock formulation). Catalysts useful for improving the kinetics of moisture cure crosslinking processes can be selected by those of ordinary skill in the art in view of this disclosure. The amount of crosslinkable monomer in the crosslinkable polymer in a composition can vary. A crosslinkable polymer composition may, for example, include at least about 0.05 wt %, or at least about 0.1 wt %, or at least about 0.25 wt %, and up to about 20 wt %, or up to about 10 wt %, or up to about 5 wt % of crosslinkable monomer.

A contrast coating can include a pigment, dye, or colorant to impart color to the coating. Conventional pigments, dyes and colorants can be used. Non-limiting examples of pigments, dyes and colorants include titanium dioxide, carbon black, copper chromite, chromium, iron oxide, manganese, cobalt, cadmium, antimony, nickel, derivatives thereof or combinations thereof. Additional non-limiting examples of pigments include those described in the Lawrence Berkeley National Laboratory Pigment Database, Berkeley, Calif., herein incorporated by reference in its entirety. Pigments, colorants and dyes can be included in a coating composition in amounts of at least about 0.01 wt %, or at least about 0.1 wt %, or at least about 1 wt %, or at least about 2 wt %, or at least about 5 wt %, or at least about 10 wt %, and up to about 50 wt %, or up to about 40 wt %, or up to about 35 wt %, or up to about 30 wt %, or up to about 28 wt %, and or up to about 20% of the coating composition. In certain embodiments with two or more contrast coatings, different colors may be used to create variations in appearance. For purposes of this disclosure, different color refers to the difference in one or more of the CIELAB color scale coordinates. In certain embodiments, it may be desirable to provide a repeating pattern or feature on a composite substrate to create a specific appearance when multiple composite substrates are placed together. In other circumstances a non-repeating design may be desired. For example, repeating patterns on WPCs attempting to mimic natural wood can adversely impact the appearance of decking boards when combined to create a larger surface. The desired design and impact can be selected and imparted onto at least a portion of a substrate's surface.

In some embodiments, an optional base coat or primer may be applied onto the composite substrate before applying at least one contrast coat. The base coat can be applied onto all surfaces of a substrate or selectively placed on at least a portion of an exposed surface. The base coat can serve as a solid background upon which the aesthetic contrast coating can be applied. The base coat can include various pigments, dyes, or colorants and other optional fillers to impart color and other desired physical characteristics. In a preferred embodiment, a base coat's composition can be selected to interact with that of any contrast coating or other coatings to enable sufficient interfacial bonding. In other embodiments, the undercoats in a series of coatings may have reduced amounts of catalysts with the exposed coating or top coat comprising greater amounts of catalysts. In this aspect, crosslinking and interfacial bonding can be enhanced.

In certain embodiments, the primer, base coat, the at least one contrast coating, or combinations thereof may include infrared reflective or absorptive pigments, colorants, or dyes or infrared transmissive additives to address the impact of solar radiation on the article.

A variety of infrared reflective pigments, colorants, or dyes can be used in the various disclosed coatings. Exemplary infrared reflective colorants dark pigments may be inorganic or organic in nature, and include but are not limited to those referred to in U.S. Pat. Nos. 6,458,848 B2, 6,616,744 B1, 6,989,056 B2 and 7,157,112 B2. Inorganic pigments are especially desirable and include single or mixed metal oxides formed from a variety of metals, e.g., from aluminum, antimony, bismuth, boron, chromium, cobalt, gallium, indium, iron, lanthanum, lithium, magnesium, manganese, molybdenum, neodymium, nickel, niobium, silicon, tin, vanadium or zinc. Exemplary metal oxides include Cr₂O₃, A1₂0₃, V₂O₃, Ga₂O₃, Fe₂O₃, Mn₂O₃, Ti₂O₃, In₂O₃, TiBO₃, NiTiO₃, MgTiO₃, CoTIO₃, ZnTiO₃, FeTiO₃, MnTiO₃, CrBO₃, NiCrO₃, FeBO₃, FeMoO₃, FeSn(BO₃)₂, BiFeO₃, AlBO₃, Mg₃Al₂Si₃O₁₂, NdAlO₃, LaAlO₃, MnSnO₃, LiNbO₃, LaCoO₃, MgSiO₃, ZnSiO₃ and Mn(Sb,Fe)O₃. The metal oxide may have a corundum-hematite crystal lattice structure as described in the above-mentioned U.S. Pat. No. 6,454,848 B2, or may be a host component having a corundum-hematite crystalline structure which contains as a guest component one or more elements selected from aluminum, antimony, bismuth, boron, chromium, cobalt, gallium, indium, iron, lanthanum, lithium, magnesium, manganese, molybdenum, neodymium, nickel, niobium, silicon, tin, vanadium and zinc. A variety of infrared reflective colorants dark pigments are commercially available, including mixed metal oxide pigments such as those supplied by Ferro Corporation (Cleveland, Ohio) under the COOL COLORS™ and ECLIPSE™ trademarks, for example V-778 COOL COLORS IR Black, V-780 COOL COLORS IR Black, V-799 COOL COLORS IR Black, 10201 ECLIPSE Black, 10202 ECLIPSE Black and 10203 ECLIPSE Black; mixed metal oxide pigments such as those supplied by Shepherd Color Company (Cincinnati, Ohio) under the ARTIC™ trademark, for example ARTIC Black 376, ARTIC Black 10C909, ARTIC Black 411 and ARTIC Black 30C940; mixed metal oxide pigments such as those supplied by Tomatec America, Inc. (Florence, Ky.) under the numbers 42-707A and 707V10; and perylene-based or other organic colorants such as those supplied by BASF (Florham Park, N.J.) under the PALIOGEN™ trademark including PALIOGEN Black S 0084. A variety of infrared reflective pigments in colors other than black may be obtained from these same or other suppliers and employed in the base paints, stains or colorant array. In some instances these pigments may also be referred to as dyes. Exemplary non-black pigments, many of which are infrared-reflective, include inorganic pigments such as titanium dioxide, iron oxide, zinc oxide, magnesium silicates, calcium carbonate, aluminosilicates, silica and various clays; organic pigments including plastic pigments such as solid bead pigments (e.g., polystyrene or polyvinyl chloride beads) and microsphere pigments containing one or more voids and vesiculated polymer particles (e.g., those discussed in U.S. Pat. Nos. 4,427,835, 4,920,160, 4,594,363, 4,469,825, 4,468,498, 4,880,842, 4,985,064, 5,041,464, 5,036,109, 5,157,084, 5,409,776, and 5,510,422). Other exemplary pigments include EXPANCEL™ 551DE20 acrylonitrile/vinyl chloride expanded particles (from Expancel Inc., Duluth, Ga.), SIL-CEL™ 43 glass micro cellular fillers (from Silbrico Corporation, Hodkins, Ill.), FILLITE™ 100 ceramic spherical particles (from Trelleborg Fillite Inc., Norcross, Ga.), SPHERICEL™ hollow glass spheres (from Potter Industries Inc., Valley Forge, Pa.), 3M ceramic microspheres including grades G-200, G-400, G-600, G-800, W-210, W-410, and W-610 (from 3M, St. Paul, Minn.); 3M hollow microspheres including 3M Performance Additives iM30K (also from 3M), INHANCE™ UH 1900 polyethylene particles (from Fluoro-Seal Inc., Houston, Tex.), and BIPHOR aluminum phosphate (from Bunge Fertilizantes S.A., Brazil). Infrared absorptive pigments may also be used. Exemplary infrared absorptive pigments include carbon black, black iron oxide, brown oxide and raw umber. Colorants or colorant arrays containing entirely inorganic pigments or pigment mixtures may be preferred where custom-tinted paints or stains having maximum exterior durability are desired.

A thermally emissive filler can be employed in coatings to reduce surface temperatures and heat build-up. A non-limiting example of thermally emissive filler includes boron nitride. Thermally emissive fillers include those disclosed in International Application No. PCT/US17/19155, herein incorporated by reference in its entirety. In certain embodiments, such fillers may lower the temperature of the exposed surface and reduce heat build-up due in part to infrared radiation. In some embodiments, the combination of an infrared reflective colorant and a thermally emissive filler can provide improved reduction in surface temperatures as well as a reduction in heat build-up within the article.

In other embodiments, a transparent colorant can be included in the various coatings. Transparent colorants offer the ability to adjust the color of a polymeric composite to a desired hue. Infrared transparent colorants include those colorants that have a high level of infrared transparency. Non-limiting examples include LUMOGEN™ organic colorants commercially marketed by BASF™ Corporation, Florham Park, N.J. These colorants are useful in that they are very dark and are well suited for the base coat, contrast coats, or both.

In another embodiment, a composite substrate may be coated in a manner to enable a significant increase in the reflection of solar energy, and in particular, infrared energy. For example, a composite substrate may include a white primer, a base coat including infrared transmissive compounds, infrared reflective compounds, or a combination thereof, optionally one or more contrast coatings and a top coat. Such embodiments may exhibit a substantial decrease in heat build-up due to the impact on energy in the infrared spectrum.

Compositions and articles made from this disclosure's methods and devices can be well-suited for building and architectural applications, such as decking, siding, railing, fencing, rooting, trim, and others. A resultant article's durability can be assessed using a scratch and mar test.

Having thus described various embodiments of the disclosed methods and devices, those of ordinary skill in the art will readily appreciate that the teachings found herein may be applied to yet other embodiments within the scope of this disclosure. The application is intended to cover any such adaptions or variations of the disclosed embodiments.

1. A method comprising:
(a) providing a composite substrate;
(b) conveying the composite substrate; and
(c) applying at least one contrast coating with a coating apparatus onto the composite substrate according to one or more indexing sequences, wherein applying the at least one contrast coating includes indexing the composite substrate or the coating apparatus to create a design of the at least one contrast coating on at least a portion of the composite substrate.

2. The method according to claim 1, wherein the coating apparatus further comprises a first coating applicator roll and a second coating applicator roll capable of being indexed according to the one or more indexing sequences.

3. The method according to claim 2, wherein the one or more indexing sequences includes positioning the first coating applicator roll at a first coating application angle and the second coating applicator roll at a second coating application angle during or between application(s) of the at least one contrast coating; wherein the first coating application angle can range from at least about 1° up to about 179° and the second coating application angle can range from at least about 1° up to about 179°.

4. The method according to claim 2, wherein the one or more indexing sequences includes positioning the first coating applicator roll at a first tilt angle and the second coating applicator roll at a second tilt angle during or between application(s) of the at least one contrast coating; wherein the first tilt angle can range from at least about 1° up to about 80° and the second tilt angle can range from at least about 1° up to about 80°.

5. The method according to claim 2, wherein the one or more indexing sequences includes rotating the first coating applicator roll at a first rotation speed and the second coating applicator roll at a second rotation speed during or between applying the at least one contrast coating; wherein a rotation speed differential between the first rotation speed and the second rotation speed ranges from at least about 5% up to about 50%.

6. The method according to claim 2, wherein the one or more indexing sequences includes positioning one or more of the composite substrate, the first coating applicator roll, or the second coating applicator roll to vary one or more of the first coating application angle, the second coating application angle, the first tilt angle, and the second tilt angle during or between application(s) of the at least one contrast coating.

7. The method according to claim 2, wherein the one or more indexing sequences includes varying one or more of the speed of conveying the composite substrate, the first rotation speed, and the second rotation speed during or between application(s) the at least one contrast coating.

8. The method according to claim 2, further comprising:
(d) providing a second composite substrate;
(e) conveying the second composite substrate; and
(f) applying the at least one contrast coating with the coating apparatus onto the second composite substrate according to a second set of one or more indexing sequences, wherein the second set of one or more indexing sequences includes indexing the second composite substrate, the coating apparatus, or some combination thereof, to create a design on at least a portion of the second composite substrate that differs from the design created in step (c).

9. The method according to claim 2, wherein the second set of one or more indexing sequences includes positioning one or more of the second composite substrate, the first coating applicator roll, or the second coating applicator roll to vary one or more of the first coating application angle, the second coating application angle, the first tilt angle, and the second tilt angle during or between application(s) of the at least one contrast coating.

10. The method according to claim 2, wherein the second set of one or more indexing sequences includes varying one or more of the speed of conveying the second composite substrate, the first rotation speed, and the second rotation speed during or between application(s) of the at least one contrast coating.

11. A method according to claim 1, further comprising drying or curing the contrast coating.

12. A method according to claim 11, wherein curing comprises thermal curing, UV curing, moisture curing or actinic energy curing.

13. A method according to claim 1, further comprising applying two or more contrast coatings to the composite substrate.

14. A method according to claim 13, wherein the two or more contrast coatings comprise at least two different colors.

15. A method according to claim 1, wherein the composite substrate comprises a base coat applied onto the composite substrate prior to applying the at least one contrast coating.

16. A method according to claim 1, wherein the at least one contrast coating or the base coat include an infrared reflective additive, an infrared transmissive additive, a thermally emissive filler, or a combination thereof.

17. A method according to claim 1, further comprising flame treating the composite substrate prior to applying the base coat or at least one contrast coating.

18. A method according to claim 1, further comprising at least partially drying or curing the at least one contrast coating on the substrate before applying another contrast coating.

19.-24. (canceled)

25. An article comprising a composite substrate having at least one contrast coating applied onto a surface of the composite substrate by the method of claim 1.

26.-30. (canceled)

31. An article comprising:
a pallet of patterned composite boards having two or different contrast coating patterns.

32. (canceled)
